(19) United States
(12) Patent Application Publication
(10) Pub. No.: US 2019/0055904 A1
(43) Pub. Date: Feb. 21, 2019

(54) Safe hydrogen fueled ic engine systems

(71) Applicant: Joseph B. Kejha, Meadowbrook, PA (US)

(72) Inventor: Joseph B. Kejha, Meadowbrook, PA (US)

(21) Appl. No.: 15/731,879

(22) Filed: Aug. 17, 2017

(51) Int. Cl. F02M 21/02; F02D 19/06

(52) U.S. Cl. CPC F02M 21/0239; F02M 21/0221; F02M 21/0278; F02D 19/0665; F02D 19/0615; F02D 19/0644; F02M 21/0206

(57) ABSTRACT

A safe hydrogen fueled IC engine system is described herein, having an electronic control of safety valves and ignition timing. The system is useable with any IC engine and especially with electric hybrid drive systems.

This Application is continuation in part of prior Provisional Patent No. of Aug. 17, 2017 No. 62/491,721 to be preserved permanently.

### FIELD OF THE INVENTION

This invention relates mostly to hydrogen fueled internal combustion (IC) engines having safety features therein and efficiency improvements at low cost.

### DESCRIPTION OF PRIOR ART

It has been recognized that there is a need for safer and lower cost propulsion systems for aircrafts, vehicles and ships than today's systems with polluting and dangerous liquid hydrocarbon fuels , or expensive fuel cells.

Liquid hydrocarbon fuels spill and ignite in accidents with horrific consequences. Electric hybrids with fuel cells running on hydrogen are safer, but they are prohibitively expensive, due to platinum used in their electrodes.

Fuel cells are many times more costly than IC engines of the same HP.

There had been difficulties with starting and running IC engines on hydrogen safely. Lower cost and safe IC engine system of the invention does not suffer from the disadvantages of the prior art.

### SUMMARY OF THE INVENTION

It has now been found that Universal, Save IC Engine System fueled by pure compressed hydrogen, having electronic controls of ignition timing modified for combustion of hydrogen and a redundant system of sensors and shut-off valves, and flame arrestors can be safer than today's engines with liquid fuels, and cost less than fuel cells systems.

It is well known that compressed hydrogen in a thick walled vessel is more safely stored fuel in an accident than liquid fuels in today's thin walled tanks, which can rupture and spill the fuel downwards, and catch on fire.

In case of hydrogen leak and ignition, hydrogen does not spill, but due to its lighter weight than air, it flies and burns upward in a narrow flame, as was shown in many tests. Also, it is very unlikely that the thick vessel would rupture even in aircraft crashes. Hydrogen is also non-polluting to the air or land, and product of its burning in the engine or outside is pure water steam, without any smoke.

Result is then a much safer and clean fuel system.

Safe hydrogen system of the invention comprises preferably a 4-cycle engine with compressed hydrogen in a vessel, having main valve and pressure reducing regulator with gauges; flame arrestor; manual valve for safety; electric valve; flow regulating needle valve for RPM control; and a stainless steel syringe needle mounted into the engine air intake. The pressure vessel is preferably made of aluminum with carbon fibers composite wrapped around it.

All above components are connected in the same sequence as listed above by copper and stainless steel tubing with leak-proof swage-lock connectors.

The engine has mounted on its output shaft a hall effect sensor, which feeds the RPM signals of the engine into Electronic Control Box with printed circuit board, microprocessor, relays, switches and interface plugs. This electronic control also delays the ignition timing to the peak of the piston position, and eliminates the second spark of the magneto type system (if used), and also controls the opening and closing of the electric valve, as programmed.

A very important feature for safety is that, if the sensor detects that the engine stopped for any reason, it automatically closes the electric valve, which stops the flow of hydrogen into the engine.

Another safety feature is that the electric valve opens only after several seconds of the engine turning by electric motor starter, and thus establishing an air flow into the intake. Only then, the engine starts running on hydrogen. This prevents a premature back firing into the intake.

The engine shaft is connected to the electric motor shaft by a flexible coupling. The electric motor , powered by a battery via a switch, is used as a starter as described above. When the engine starts running on hydrogen, the electric motor becomes a DC generator, recharging the battery. The battery has a voltage regulator, protecting it from overcharge.

This battery can be connected to another electric motor with electric RPM controls and this system thus becomes a Series Hydrogen Electric Hybrid Propulsion System, useable in many applications, like long range and safer non-polluting UAVs, aircrafts, vehicles and ships, indoor forklifts cheaper than fuel cell forklifts, garden equipment, etc.

The battery or batteries of the system never get fully discharged, and take only the peak loads. Hydrogen can be replenished into the vessel in 3 minutes, versus hours of electric charging.

This hybrid system is not only cheaper than electric only, or fuel cell systems, but also is very hydrogen fuel efficient, due to having 3× smaller engine than IC only system.

A parallel hybrid version would have only one electric motor/generator on the engine shaft, electric clutch , and the battery with voltage regulator. In both electric hybrid systems, the engine preferably runs at fixed optimum RPM to maximize the efficiency and thus duration and range.

For applications requiring a larger IC engine only, manually or otherwise started without the electric motor, the Electronic Box has another bi-fuel feature by a selector switch:

The engine starts on a small amount of gasoline or ethanol from a small auxiliary tank, to get the air flow going for a few seconds, and then the Electronic Box opens the hydrogen flow by the electric valve, and then closes the gasoline or ethanol line by another valve. After that, the engine runs only on hydrogen. RPMs are controlled by the needle valve. This system will have shorter runs on the same amount of fuel, due to higher consumption of hydrogen by peak loads and by the larger engine, but it has a lower cost and lower weight at the same HP and duration than any known electric only system, and is also very clean, because the liquid fuel is used only for a few seconds.

Hydrogen should be of course produced only from renewable, or carbon neutral sources, like bio-waste, or splitting water in a reversed, low cost solid oxide fuel cell powered by solar electricity, as well as the compressor.

The principal object of this invention is to provide safe, clean and low cost hydrogen propulsion system for aircrafts, vehicles and ships, which can replace dangerous and polluting IC engine liquid fuel systems and expensive fuel cell propulsion systems.

A further object of the invention is to provide environmentally friendly propulsion system, which has lower cost, is lighter, and has a longer range than electric only propulsion systems.

Other objects and advantages of the invention will be apparent from the description and appended claims.

### DESCRIPTION OF THE DRAWINGS

The nature and characteristic features of the invention will be more readily understood from the following description taken in connection with the accompanying drawing forming part thereof, in which:

FIG. 1 is a diagrammatic view of the safe hydrogen fueled IC engine system with series electric hybrid drive system, illustrating their components.

FIG. 2 is a diagrammatic view of the safe hydrogen fueled IC engine system with parallel electric hybrid drive system, illustrating their components.

FIG. 3 is a diagrammatic view of the safe hydrogen fueled IC engine system with direct drive, illustrating its components.

It should, of course be understood that the description and drawings herein are merely illustrative, and that various modifications, combinations, and changes can be made in the structures disclosed without departing from the spirit of the invention.

### DESCRIPTION OF THE PREFERRED EMBODIMENTS

When referring to the preferred embodiments, certain terminology will be utilized for the sake of clarity. Use such terminology is intended to encompass not only the described embodiments, but also technical equivalents, which operate and function in substantially the same way to bring about the same result.

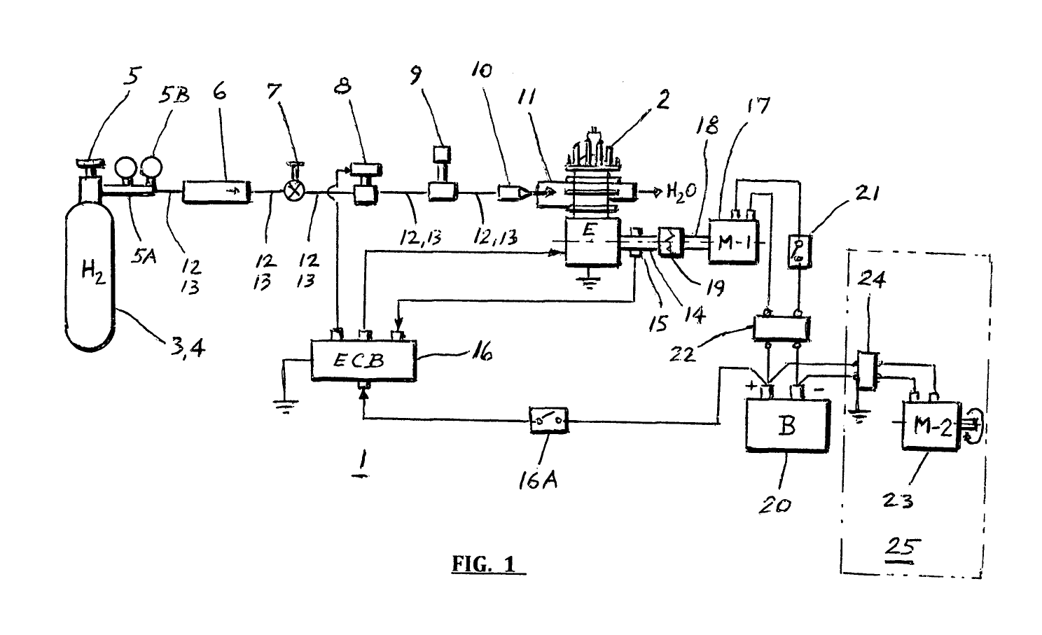

Referring now to the drawing FIG. 1, a preferred Universal, Save IC Engine System 1 fueled by pure compressed hydrogen is herein illustrated, and which is one embodiment of the invention. The system has compressed hydrogen in a vessel and electronic controls of ignition timing modified for combustion of hydrogen, and have a redundant system of sensors and shut-off valves, and flame arrestors, which makes it safer than today's engines with liquid fuels, and also costs less than fuel cells systems.

It is well known that compressed hydrogen in a thick walled vessel is more safely stored fuel in an accident than liquid fuels in today's thin walled tanks, which can rupture and spill the fuel downwards, and catch on fire.

In case of hydrogen leak and ignition, hydrogen does not spill, but due to its lighter weight than air , it flies and burns upward in a narrow flame, as was shown in many tests. Also, it is very unlikely that the thick vessel would rupture even in aircraft crashes. Hydrogen is also non-polluting to the air or land, and product of its burning in the engine or outside is pure water steam, without any smoke.

Result is then a much safer and clean fuel system.

Safe hydrogen IC engine system of the invention 1 comprises preferably 4-cycle engine 2 with compressed hydrogen 3 in ,vessel 4 , having main valve 5 and pressure reducing regulator SA with gauges 5B; flame arrestor 6; manual valve 7 for safety electric solenoid valve 8; flow regulating needle valve 9 for RPM control;

and a stainless steel syringe needle 10, mounted into the engine air intake 11. The vessel 4 is preferably made of aluminum with unidirectional carbon fiber composite wrapped around it.

All above components are connected in the same sequence as listed above by copper and stainless steel tubings 12 with leak-proof swage-lock connectors 13. The engine 2 has mounted on its output shaft 14 a hall effect sensor 15, which feeds the RPM signals of the engine 2 into Electronic Control Box 16, powered by battery 20 via switch 16A. The Box 16 has printed circuit board, microprocessor, preferably solid state relays, switches and interface plugs therein (not shown).

This electronic control Box 16 also delays the ignition timing to the peak of the engine 2 piston position, and eliminates the second spark of the magneto type system (if used), and also controls the opening and closing of the electric valve 8, as programmed. A very important feature for safety is that, if the sensor 15 detects that the engine 2 stopped for any reason, the Box 16 automatically closes the electric valve 8, which stops the flow of hydrogen 3 into the engine 2.

Another safety feature is that the electric valve 8 opens only after several seconds of the engine 2 turning by electric motor starter 17, and thus establishing an air flow into the intake 11. Only then, the engine 2 starts running on hydrogen 3.

This prevents a premature back firing into the intake 11.

The engine 2 shaft 14 is connected to the electric motor 17 shaft 18 by flexible coupling 19. The electric motor 17, powered by the battery 20 via switch 21, is used as a starter as described above. When the engine 2 starts running on hydrogen, the electric motor 17 becomes a DC generator, recharging the battery 20. The battery 20 has voltage regulator 22, protecting it from overcharge.

This battery 20 can be connected to another electric motor 23 with electric RPM controls 24 and this system thus becomes a Series Hydrogen Electric Hybrid Propulsion System 25, which is another embodiment of the invention, useable in many applications, like long range and safer non-polluting UAVs, aircrafts, vehicles and ships, indoor forklifts cheaper than fuel cell forklifts, etc.

The battery or batteries 20 never get fully discharged, and take only the peak loads. The engine 2 will stop when battery 20 is full, and will start again when the battery 20 voltage drops to a preset level. This is also controlled by the Electronic Control Box 16. Hydrogen 3 can be replenished into the vessel 4 in 3 minutes, versus hours of electric charging.

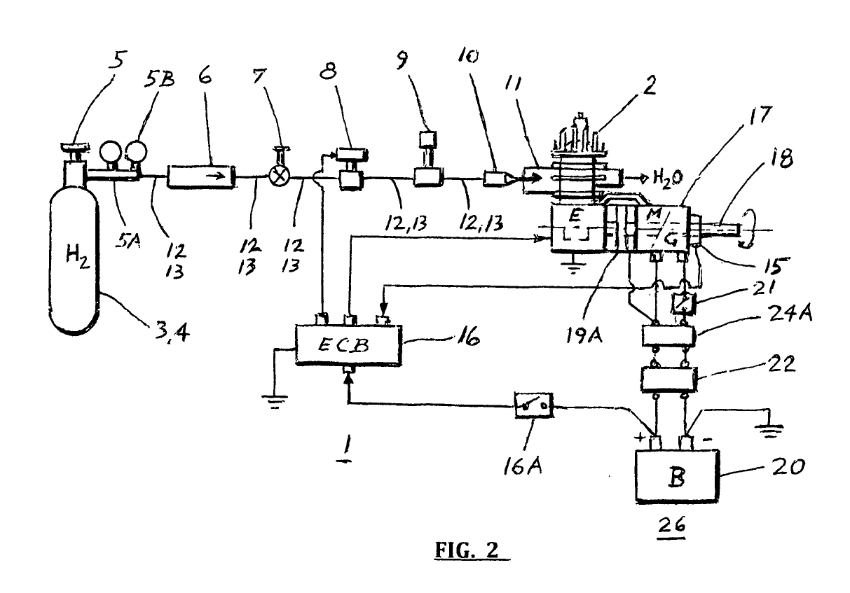

This hybrid system is not only cheaper than electric only, or fuel cell systems, but also is very hydrogen fuel efficient, due to having 3× smaller engine than IC only system, and the engine 2 runs only when the battery 20 recharge is needed. Referring now to FIG. 2, showing a parallel electric hybrid version 26, which has only one electric motor/generator 17A connected to the engine shaft 18 by electric clutch 19A, and has the battery 20 with the voltage regulator 22. The clutch and the motor/generator 17A RPM are controlled by control unit 24A. The clutch 19A is disconnected when the battery 20 is fully charged, or when the motor 17A is not needed to assist the engine 2 with an additional torque.

Hereby the safety components and features of the system 1 are the same as shown and described with the system 25. This is another embodiment of the invention. In the series electric hybrid system 25, the engine preferably runs at fixed optimum RPM to maximize the efficiency, and thus duration and range. This also simplifies the engine 2 controls.

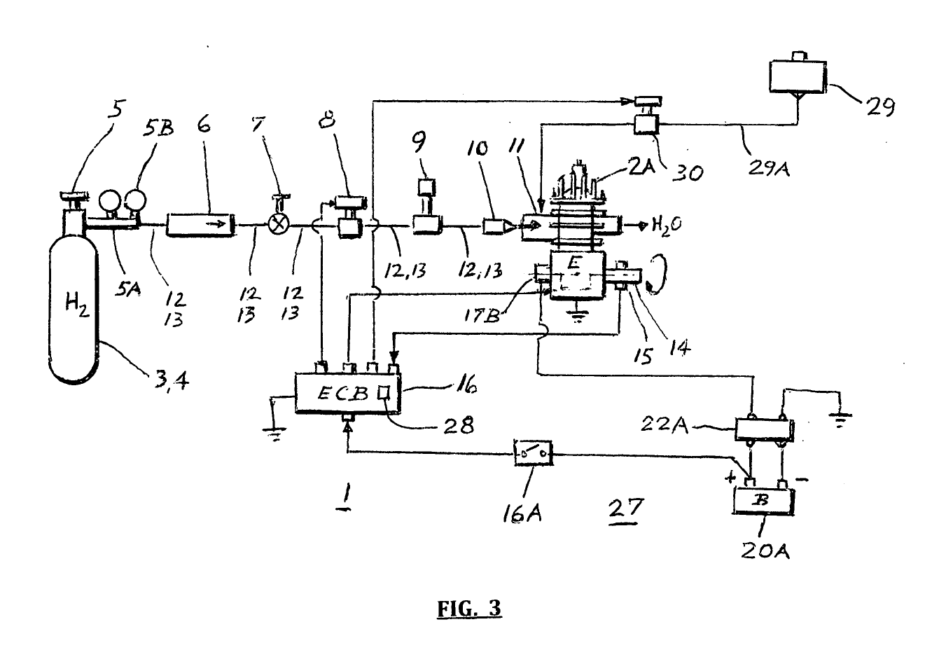

Referring now to FIG. 3, showing a safe hydrogen fueled IC system 27 with a larger IC engine 2A only, manually or otherwise started without the electric motor 17. The Electronic Box 16, powered by a small battery 20A via switch 16A has another bi-fuel feature by a selector switch 28:

The engine 2A starts on a small amount of gasoline or ethanol from a small, preferably thick walled tank 29, to get the air flow going for a few seconds, and then the Electronic Box 16 opens the hydrogen flow by the electric valve 8, and then closes the gasoline or ethanol line 29A by another valve 30. After that, the engine 2A runs only on hydrogen 3 from the vessel 4. RPM are controlled by the needle valve 9. The small battery 20A is recharged by DC mini-generator 17B, driven by the engine 2A, and is protected by voltage controller 22A. The battery 20A and the mini generator 17B provide power only to the electronic box 16 and to the electric valves 8 and 30. This system will have a shorter run on the same amount of fuel than the electric hybrid systems, due to higher consumption of hydrogen 3 by peak loads and by the larger engine 2A, but it has a lower cost and lower weight than any known electric only system of the same HP and duration, and is also very clean, because the liquid fuel is used only for a few seconds. Hereby the safety components and features as described and shown of the system 1 are also the same. This is another embodiment of the invention.

The engine 2A can also be started by a well known starter motor system with a small battery and an alternator (not shown).

Typical applications would be a garden and farm equipment, golf carts, UAVs, and bicycles with assist engine.

All above systems can be made redundant for more safety by doubling outputs from the electronic box 16, and doubling the sensor 15, electric valves 8 and 30, and flame arrestor 6.

It is apparent to a person skilled in the art , that these described safe hydrogen systems can also be used for or with multi-piston IC engines, and free piston valve-less Aquarius cycle IC engines, or other free piston IC engines with linear generators, when having a manifold for distribution of hydrogen into each air intake (not shown).

Hydrogen should be of course produced separately, only from renewable or carbon neutral sources, like bio-waste, or by splitting water in a reversed, low cost solid oxide fuel cell powered by solar electricity, as well as the compressor.

It will thus been seen, that lower cost, clean and safer hydrogen fueled propulsion systems are herein described, with which the objects of the invention are achieved.

I claim:

1. A safe hydrogen fueled internal combustion (IC) engine system, comprising an internal combustion engine having an output shaft and intake and an ignition system; compressed hydrogen in a vessel and said hydrogen in said vessel is connected with said engine intake by a tubing via main valve mounted on said vessel; pressure reducing regulator with gauges; a flame arrestor; a manual closing valve; an electric valve, a flow regulating needle valve for RPM control; a metal syringe needle mounted into said engine intake; a revolutions sensor on said output shaft; an electronics control box controlling said electric valve's closing and opening and said engine ignition timing, powered by a battery; and an electric starter/generator connected with said battery via a switch.

2. A safe hydrogen fueled IC engine system as described in claim 1, in which said shall sensor detects if said engine stopped, and sends a signal into said electronic box, which box instantly closes said electric valve.

3. A safe hydrogen fueled IC engine system as described in claim 1, in which said electronic box opens said electric valve only after a several seconds of said engine turning by said starter, and which turning is sensed by said sensor.

4. A safe hydrogen fueled IC engine system as described in claim 1, which safe system is used in combination with an electric hybrid drive system.

5. A safe hydrogen fueled IC engine system as described in claim 1, in which said electric starter/generator is replaced with a mechanical starter and a temporary liquid fuel.
